(19) United States
(12) Patent Application Publication
(10) Pub. No.: US 2024/0269737 A1
(43) Pub. Date: Aug. 15, 2024

(54) STOPPER FOR CONTINUOUS CASTING

(71) Applicant: KROSAKIHARIMA CORPORATION, Fukuoka (JP)

(72) Inventors: Shinichi FUKUNAGA, Fukuoka (JP); Toshio KAKU, Fukuoka (JP); Hiroki FURUKAWA, Fukuoka (JP)

(73) Assignee: KROSAKIHARIMA CORPORATION, Fukuoka (JP)

(21) Appl. No.: 18/567,590

(22) PCT Filed: May 31, 2022
(86) PCT No.: PCT/JP2022/022210

§ 371 Date: Dec. 6, 2023

(30) Foreign Application Priority Data
Jun. 10, 2021 (JP) 2021-097589

(51) Int. Cl. B22D 41/18; F27D 3/14

(52) U.S. Cl. CPC B22D 41/18; F27D 3/14

(57) ABSTRACT

A stopper for continuous casting that is intended to prevent adhesion of inclusions to the vicinity of a fitting part of a stopper, and to prevent a nose region of the stopper from cracking or peeling off due to insufficient strength. The stopper for continuous casting includes a gas flow cavity in a vertically-extending central part thereof. In at least part of a vertical section of a nose periphery region of the stopper, a porous refractory material having a gas permeability is arranged on the side of an outer peripheral surface of the nose periphery region. A refractory material having higher strength than that of the porous refractory material is arranged on the side of an inner peripheral surface of the nose periphery region.

### TECHNICAL FIELD

The present invention relates to a stopper for continuous casting configured such that, when discharging molten steel mainly from a tundish to a mold during continuous casting of molten steel, the stopper is fitted in a nozzle installed in the bottom of the tundish, from above the nozzle, thereby controlling the flow rate of the molten steel, wherein the stopper has a gas injection function.

### BACKGROUND ART

Heretofore, there has been a problem that inclusions such as alumina adhere to the vicinities of fitting parts of a stopper and a nozzle in a tundish of a continuous casting system. For example, during casting, if inclusions adhere to the vicinity of the fitting part of the stopper, and a layer of the adhered inclusions is peeled off, a gap between the stopper and the nozzle becomes large momentarily, and a large amount of molten steel is supplied, thereby causing the occurrence of fluctuation of a molten metal surface in a mold. Consequently, powder entrainment or the like occurs in the mold, i.e., powder, inclusions, etc. are entrained in a slab, leading to a problem that flaws or defects due to inclusions occur in a product. Therefore, it is necessary to suppress adhesion of inclusions to the vicinity of the fitting part of the stopper.

As a technique for suppressing adhesion of inclusions to the vicinity of the fitting portion of the stopper, there has been known a technique of forming a part of a nose (tip end) region of the stopper from a porous refractory material (see, for example, the following Patent Document 1). There has also been known a configuration in which a through-hole is provided in the nose region of the stopper (see, for example, the following Patent Document 2).

### CITATION LIST

### Patent Document

Parent Document 1: JP-A H02-006040

Parent Document 2: JP-A H03-110048

### SUMMARY OF INVENTION

### Technical Problem

For example, as shown in FIG. 4 of the Patent Document 1, in a configuration in which the nose of a stopper is composed of a porous nose portion 76, gas will be injected only from the porous nose portion 76. Thus, this configuration cannot suppress the adhesion of inclusions to the vicinity of the fitting part of the stopper. There has also be known a configuration in which a porous nose section 66 is sandwiched by a low permeability refractory material in a vertical (up-down) direction of a nose region of a stopper, as shown in FIG. 3 of the Parent Document 1. In this configuration, as viewed along a horizontal (transverse) section of the stopper, the whole area is composed of a porous material (porous nose section 66). Thus, this configuration is insufficient in structural strength. For this reason, the porous nose section 66 is likely to crack or peel off due to shock, vibration or the like during the flow-rate control in the course of casting.

On the other hand, as shown in the Patent Document 2, in a configuration in which a through-hole is provided in a nose region of a stopper, it is necessary to provide a large number of through-holes (as shown in, e.g., FIG. 5) so as to suppress the adhesion of alumina inclusions. Thus, there has been a problem that a manufacturing process becomes complicated, leading to an increase in manufacturing costs. Further, gas bubbles injected from the through-hole do not become fine gas bubbles like those injected from a porous refractory material, and there has been a problem of failing to suppress the adhesion of the inclusions. Moreover, in such a configuration in which a through-hole is provided, the diameter of the through-hole is generally as large as 2 to 5 mm. In this case, the diameter of each gas bubble becomes large, and the effect of suppressing the adhesion of the inclusions cannot be produced. Boiling in a mold is also likely to occur, and powder entrainment is likely to occur.

It is therefore an object of the present invention to suppress the adhesion of inclusions to the vicinity of the fitting part of a stopper, and to prevent a nose region of the stopper from cracking or peeling off due to insufficient strength.

### Solution to Technical Problem

According to one aspect of the present invention, there is provided a stopper for continuous casting, which comprises a gas flow cavity in a central part thereof, wherein, in at least part of a vertical section of a nose periphery region of the stopper, a porous refractory material having a gas permeability is arranged on the side of an outer peripheral surface of the nose periphery region, and a refractory material having higher strength than that of the porous refractory material is arranged on the side of an inner peripheral surface of the nose periphery region.

### Effect of Invention

According to the present invention, bubbles of gas injected into molten steel from the porous refractory material arranged on the side of the outer peripheral surface of the nose periphery region of the stopper are drawn to the vicinity of a fitting part of the stopper by the molten steel. Thus, the gas bubbles are supplied to the vicinity of the fitting part of the stopper, so that it becomes possible to suppress the adhesion of inclusions such as alumina to the vicinity of the fitting part of the stopper. Further, the bubbles of gas injected from the porous refractory material into the molten steel become finer than bubbles of gas injected from a through-hole into molten steel. Thus, it becomes possible to more effectively suppress the adhesion of inclusion as compared to the configuration in which gas is injected from a through-hole into molten steel. Further, the refractory material having higher strength than the porous refractory material is arranged on the side of the inner peripheral surface of the nose periphery region of the stopper. Thus, it becomes possible to prevent a nose region of the stopper, particularly, the nose periphery region, from cracking or peeling off due to insufficient strength.

### BRIEF DESCRIPTION OF DRAWINGS

FIG. 1 is a vertical sectional view of a stopper for continuous casting, according one embodiment of the present invention.

FIG. 2 is a cross-sectional view showing one aspect of the arrangement of a porous refractory material, taken along the line A-A of FIG. 1.

FIG. 3 is a cross-sectional view showing another aspect of the arrangement of the porous refractory material, taken along the line A-A of FIG. 1.

FIG. 4 is a graph showing the result of a water model test.

### DESCRIPTION OF EMBODIMENTS

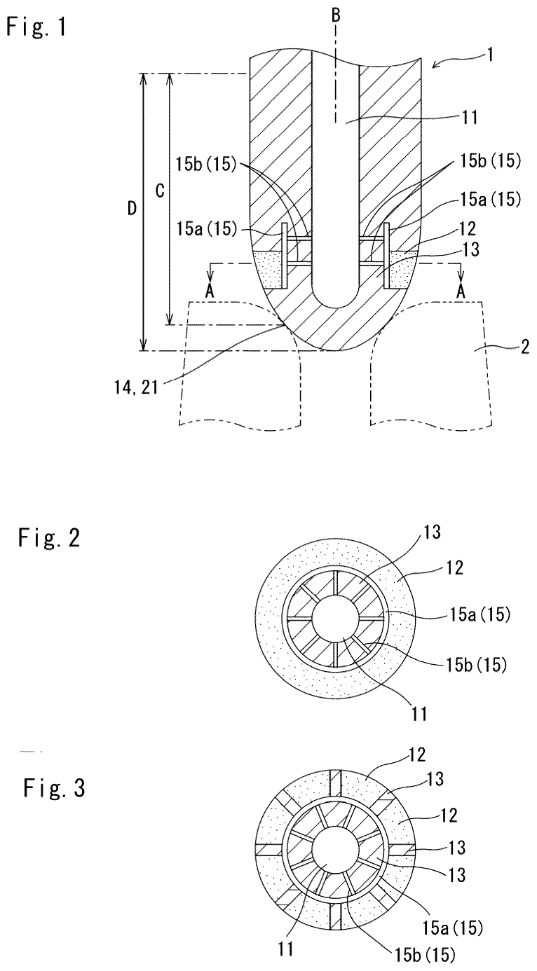

FIG. 1 is a vertical sectional view of a stopper for continuous casting (hereinafter referred to simply as “stopper”) according one embodiment of the present invention. FIG. 2 is a cross-sectional view taken along the line A-A of FIG. 1. Here, the vertical section of the stopper 1 means a longitudinal section of the stopper 1 passing through a vertical central axis B of the stopper 1. Further, in FIG. 1, a nozzle 2 in which the stopper 1 is to be fitted from thereabove is shown by imaginary lines. Specifically, this nozzle 2 is a nozzle (upper nozzle) installed in the bottom of a tundish.

The stopper 1 comprises a gas flow cavity 11 in a vertically-extending central part thereof. Further, in at least part of the vertical section of a nose periphery region C of the stopper 1, a porous refractory material 12 having a gas permeability is arranged on the side of an outer peripheral surface of the nose periphery region C, and a refractory material 13 having higher strength than the porous refractory material 12 (hereinafter referred to as “high-strength refractory material”) is provided on the side of an inner peripheral surface of the nose periphery region C.

Here, the nose periphery region C of the stopper 1 means a partial nose region located above a fitting part 14 of the stopper 1 with respect to the nozzle 2. Further, as used in this specification, the entire nose region, i.e., the sum of the nose periphery region C and a partial nose region below the fitting part 14 of the stopper 1, will be referred to as “nose region D of the stopper”.

In the present invention, the porous refractory material 12 is arranged on the side of the outer peripheral surface in at least part of the vertical section of the nose periphery region C. More specifically, the porous refractory material 12 is preferably arranged in a region spaced above the fitting part 14 of the stopper 1 by a distance of 10 mm to 250 mm. This is based on the after-mentioned water model test result, etc.

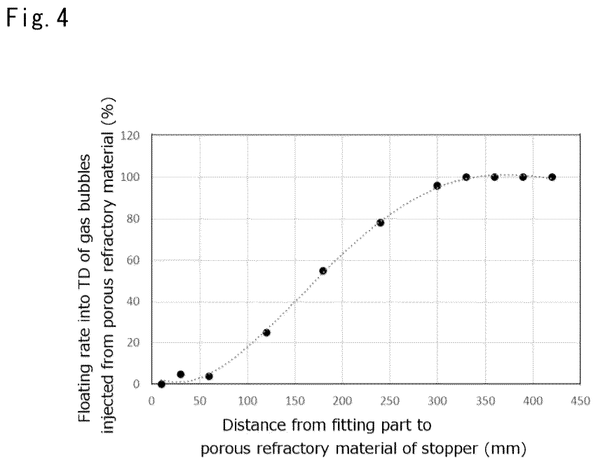

FIG. 4 shows the results of a water model test. In the water model test, a floating rate into a tundish (TD) of gas bubbles injected from the porous refractory material 12 was measured while changing the arrangement position of the porous refractory material 12, i.e., the distance from the fitting part 14 to the porous refractory material 12, in a contact state between the stopper 1 and the nozzle 2 (upper nozzle installed in the bottom of the tundish) as shown in FIG. 1. The water model test was performed by adjusting a gap between the fitting part 14 of the stopper 1 and a fitting part 21 of the nozzle 2 such that a water passing amount was set to 0.42 m³/min. This water passing amount: 0.42 m³/min, is equivalent to a casting amount of 3 t/min. The flow rate of gas injected from the porous refractory material 12 into water was set to 5 L/min, and the diameter of each gas bubble injected from the porous refractory material 12 was set to about 0.3 to 1 mm. The distance from the fitting part 14 to the porous refractory material 12 means the distance from the fitting part 14 to the lower end of the porous refractory material 12.

As shown in FIG. 4, as the distance from the fitting part 14 to the porous refractory material 12 becomes larger, the floating rate into the tundish of gas bubbles injected from the porous refractory material 12 becomes higher. The higher floating rate into the tundish means that gas bubbles to be supplied to the vicinity of the fitting part 14 is reduced. Thus, from a viewpoint of suppressing the adhesion of inclusions to the vicinity of the fitting part 14, it is desirable to reduce the distance from the fitting part 14 to the porous refractory material 12. From the water model test result of FIG. 4, it is understandable that if the distance from the fitting part 14 to the porous refractory material 12 is about 250 mm or less, the floating rate into the tundish can be suppressed to less than about 80%. Thus, the distance from the fitting part 14 to the porous refractory material 12 is preferably set to about 250 mm or less. In other words, in this embodiment, the nose periphery region C where the porous refractory material 12 is arranged means a region spaced above the fitting part 14 by a distance of about 250 mm. From a viewpoint of further reducing the floating rate into the tundish of gas bubbles injected from the porous refractory material 12 and further increasing gas bubbles supplied to the vicinity of the fitting part 14, the distance from the fitting part 14 to the porous refractory material 12 is more preferably set to 150 mm or less, much more preferably 100 mm or less. On the other hand, the lower limit of the distance from the fitting part 14 to the porous refractory material 12 is not particularly limited. However, from a viewpoint of securing the strength of the fitting part 14, the distance from the fitting part 14 to the porous refractory material 12 is preferably set to 10 mm or more.

Next, an aspect of the arrangement of the porous refractory material 12 will be described. In one aspect of this embodiment, as shown in FIG. 2, the porous refractory material 12 is arranged entirely circumferentially on the side of an outer peripheral surface of the nose periphery region, in at least part of the vertical section of the nose periphery region. By arranging the porous refractory material 12 entirely circumferentially on the side of the outer peripheral surface, it becomes possible to uniformly supply the bubbles of gas injected from the porous refractory material 12 to the vicinity of the fitting part 14 of the stopper 1. Instead of arranging the porous refractory material 12 entirely circumferentially on the side of the outer peripheral surface, the porous refractory material 12 may be arranged on the side of the outer peripheral surface in the vertical section of the nose periphery region C, in a dispersed state and in adjacent relation to the high-strength refractory material 13, as shown in FIG. 3. Even when the porous refractory material 12 is arranged in a dispersed state, the bubbles of gas injected from the porous refractory material 12 can be approximately uniformly supplied to the vicinity of the fitting part 14 of the stopper 1. Further, when the porous refractory material 12 is arranged in a dispersed state, the high-strength refractory material 13 is disposed on the side of the outer peripheral surface, so that the effect of preventing the nose periphery region C from cracking or peeling off due to insufficient strength can be significantly produced as compared to the case where the porous refractory material 12 is arranged entirely circumferentially on the side of the outer peripheral surface.

In FIG. 3, the porous refractory material 12 is divided into eight pieces, and arranged in a dispersed state. However, the number of divisions of the porous refractory material 12 is not limited thereto. Specifically, from a viewpoint of uniformly supplying the bubbles of gas injected from the porous refractory material 12 to the vicinity of the fitting part 14 of the stopper 1, it is desirable to increase the number of divisions of the porous refractory material 12. However, as the number of divisions of the porous refractory material 12 becomes larger, manufacturing becomes complicated, leading to an increase in manufacturing costs. Thus, the number of divisions of the porous refractory material 12 may be appropriately determined in consideration of balance between these factors.

In this embodiment, the porous refractory material 12 is arranged in the form of a single layer in part of the vertical section of the nose periphery region C, as shown in FIG. 1. Alternatively, for example, a layer of the porous refractory material 12 as shown in FIG. 2 or 3 may be additionally arranged on the layer of the porous refractory material 12 of FIG. 1, or the porous refractory material 12 may be formed and arranged on the side of the outer peripheral surface in the entire vertical section of the nose periphery region C.

Next, materials, physical properties, etc. of the porous refractory material 12 and the high-strength refractory material 13 will be described. Firstly, the porous refractory material 12 may be formed using an alumina-graphite based material which is a typical stopper material. Then, the particle size composition of a raw material mixture, the rate of a volatile matter content in the raw material mixture, etc., are adjusted to adjust the gas permeability, pore size, etc., of the porous refractory material 12. The gas permeability of the porous refractory material 12 may be set in the range of about 2×10⁻¹⁵ M² to about 5×10⁻¹⁴ M₂.

Here, the thickness (horizontal dimension in the vertical section of the nose periphery region C (FIG. 1)) of the porous refractory material 12 is preferably 5 mm or more. When the thickness of the porous refractory material 12 is set to 5 mm or more, the porous refractory material 12 becomes less likely to peel off. Further, since the thickness of the porous refractory material 12 can be sufficiently ensured, it is possible to obtain an effect of being able to be more easily manufactured. More preferably, the thickness of the porous refractory material 12 is set to 10 mm or more. The height (vertical dimension in the vertical section of the nose periphery region C (FIG. 1)) of the porous refractory material 12 is preferably set to 15 mm or more. When the height of the porous refractory material 12 is set to 15 mm or more, it becomes possible to inject a sufficient amount of gas from the porous refractory material 12 into molten steel.

In this embodiment, the high-strength refractory material 13 is used in a portion of the stopper other than the porous refractory material 12, and may be formed using an alumina-graphite based material which is a typical stopper material. The high-strength refractory material 13 preferably has a room-temperature bending strength of 105 or more as represented as an index calculated based on the assumption that the room-temperature bending strength of the porous refractory material 12 is 100. That is, when the room-temperature bending strength of a refractory material arranged on the side of an inner peripheral surface of the porous refractory material 12 is set to 105 or more, as represented, as the index calculated based on the assumption that the room-temperature bending strength of the porous refractory material 12 is 100, it becomes possible to significantly produce the effect of preventing the nose periphery region C from cracking or peeling due to insufficient strength. More preferably, the room-temperature bending strength of the high-strength refractory material 13 is set to 110 or more, as represented as the index calculated based on the assumption that the room-temperature bending strength of the porous refractory material 12 is 100. Although the upper limit of the room-temperature bending strength of the high-strength refractory material 13 is not particularly limited, it is realistically set to about 300, as represented as the index calculated based on the assumption that the room-temperature bending strength of the porous refractory material 12 is 100.

In this embodiment, the gas permeability of the porous refractory material material 12 is greater than that of the high-strength refractory material material 13. Specifically, the gas permeability of the porous refractory material 12 may be set to 300 or more, as represented as an index calculated based on the assumption that the gas permeability of the high-strength refractory material 13 as measured based on JIS-R2115 is 100. Although the upper limit of the gas permeability of the high-strength refractory material 13 is not particularly limited, it is realistically set to about 9000, as represented as the index calculated based on the assumption that the gas permeability of the high-strength refractory material 13 is 100.

Next, a gas injection function of the stopper 1 will be described. The stopper 1 comprises a gas flow cavity 11 in a vertically-extending central part thereof, as mentioned above, and gas supplied to the cavity 11 is injected from the porous refractory material 12 into molten steel. For this purpose, the stopper 1 comprises a gas passing path 15 to allow gas to flow from the cavity 11 to the porous refractory material 12. In this embodiment, the gas passing path 15 is composed of a slit-shaped gas pool 15a provided between the inner peripheral surface of the porous refractory material 12 and an outer peripheral surface of the high-strength refractory material 13, and a through-hole 15b connecting from the cavity 11 to the gas pool 15a. In this embodiment, the through-holes 15b is provided in a two-stage manner, as shown in FIG. 1, wherein each stage is composed of eight through-holes, as shown in FIGS. 2 and 3, i.e., sixteen through-holes are provided in total. That is, gas supplied to the cavity 11 is supplied to the porous refractory material 12 via the sixteen through-holes 15b and the gas pool 15a, and is injected from the porous refractory material 12 into molten steel. Although not illustrated in FIGS. 1 to 3, the gas pool 15a has a bridging portion which partly bridges between the inner peripheral surface of the porous refractory material 12 and the outer peripheral surface of the high-strength refractory material 13.

It should be noted here that the configuration of the gas passing path 15 is not limited to the configuration shown in FIGS. 1 to 3. For example, gas may be supplied via the through-hole 15b directly to the porous refractory material 12 without providing the gas pool 15a. However, from a viewpoint of uniformly supplying gas to the porous refractory material 12, it is preferable to provide a slit-shaped gas pool on the side of the inner peripheral surface of the porous refractory material 12. The amount of gas to be injected from the stopper may be set in the range of 1 L/min to 15 L/min.

Such a stopper 1 can be obtained by: arranging a mixture for forming the porous refractory material 12 and a mixture for forming the high-strength refractory material 13 at respective given positions in a molding form; in order to form the gas passing path 15, arranging a material capable of disappearing through heat treatment to have the shape of the gas passing path 15; and after molding, subjecting the resulting molded body to heat treatment. By integrally molding the mixture for forming the porous refractory material 12 and the mixture for forming the high-strength refractory material 13 in the above manner, at least a vertical boundary between the porous refractory material 12 and the high-strength refractory material 13 becomes a joint-less continuous structure, as shown in FIG. 1. Thus, it becomes possible to significantly produce an advantageous effect of preventing the nose periphery region C from cracking or peeling off due to insufficient strength. It also becomes possible to prevent a metal from entering between the porous refractory material 12 and the high-strength refractory material 13.

As above, according to the above embodiment, bubbles of gas injected into molten steel from the porous refractory material 12 disposed on the side of the outer peripheral surface of the nose periphery region C of the stopper 1 are drawn to the vicinity of the fitting part 14 of the stopper by the molten steel. In this way, the gas bubbles are supplied to the vicinity of the fitting part 14 of the stopper, so that it is possible to suppress the adhesion of inclusions such as alumina in the vicinity of the fitting part 14 of the stopper. Further, the bubbles of gas injected from the porous refractory material 12 into the molten steel become finer than bubbles of gas injected from a through-hole into molten steel. Thus, it becomes possible to more effectively suppress the adhesion of inclusion as compared to the configuration in which gas is injected from a through-hole into molten steel. Further, the high-strength refractory material 13 is arranged on the side of the inner peripheral surface of the nose periphery region C of the stopper, so that it is possible to prevent the nose region D of the stopper, particularly, the nose periphery region C, from cracking or peeling off due to insufficient strength.

### EXAMPLES

A continuous casting test configured to perform flow rate control of molten steel using each stopper of Examples and Comparative Examples shown in Table 1 was conducted, and the state of the nose region of the stopper and the state of the adhesion of inclusions in the vicinity of a fitting part of the stopper were evaluated. The continuous casting test was conducted under conditions that the number of casting charges (ch) was set to 6 ch. Other casting conditions (casting speed, casting size, etc.) are set to common-used conditions.

Alumina-graphite based refractory material was adapted as a material for both the porous refractory material and the high-strength refractory material used in each stopper of Examples and Comparative Examples. In each stopper of Examples 1 to 3, the porous refractory material on the side of the outer peripheral surface was arranged in a region spaced above the fitting part of the stopper by a distance of 20 to 50 mm. That is, the height (height dimension) of the porous refractory material on the side of the outer peripheral surface in each stopper of Examples 1 to 3 was set to 30 mm. On the other hand, the thickness of the porous refractory material on the side of the outer peripheral surface in each stopper of Examples 1 to 3 is as shown in Table 1. Here, in each stopper of Examples 1 to 3, the thickness of the porous refractory material on the side of the outer peripheral surface varies in a height direction. In Table 1, the minimum thickness in the height direction was set down. The room-temperature bending strength of each of the porous refractory material on the side of the outer peripheral surface and the high-strength refractory material on the side of the inner peripheral surface in each stopper of Examples 1 to 3 was measured based on JIS-R2213 using a test piece of 20×20×70 mm. In Table 1, the room-temperature bending strength of the high-strength refractory material on the side of the inner peripheral surface is notated as an index calculated based on the assumption that the room-temperature bending strength of the porous refractory material is 100.

Among evaluations of the continuous casting test, the state of the nose region of each stopper was evaluated by visually checking the state of the nose region of the stopper after the continuous casting test. Further, the state of the adhesion of inclusions in the vicinity of the fitting part of each stopper was evaluated by measuring the thickness of adhered inclusions in the vicinity of the fitting part of each stopper of Examples after the continuous casting test. In Table 1, it is notated as an index calculated on the assumption that the thickness of adhered inclusions in the vicinity of the fitting part of the stopper of Comparative Example 1 is 100.

TABLE 1

| | | | | Comparative | Comparative |
|---|---|---|---|---|---|
| | Example 1 | Example 2 | Example 3 | Example 1 | Example 2 |
| Arrangement of | FIG. 2 of present | FIG. 3 of present | FIG. 2 of present | FIG. 4 of Patent | FIG. 3 of Patent |
| Porous Refractory | application | application | application | Document 1 | Document 1 |
| Material | Entire circumference | Dispersed state | Entire circumference | Only at end | No high-strength |
| | on outer peripheral | (eight divisions) | on outer peripheral | of stopper | refractory material |
| | surface side | | surface side | | on inner peripheral |
| | | | | | surface side |
| Thickness of | 25 | 25 | 5 | | |
| Porous Refractory | | | | | |
| Material (mm) | | | | | |
| Room-Temperature | 155 | 155 | 105 | | |
| Bending Strength | | | | | |
| of High-Strength | | | | | |
| Refractory Material | | | | | |
| on Inner Peripheral | | | | | |
| Surface Side (index) | | | | | |
| State of Nose | Absence of | Absence of | Absence of | Absence of | Falling-off |
| Region | cracking and | cracking and | cracking and | cracking and | |
| | peeling-off | peeling-off | peeling-off | peeling-off | |
| Thickness of | 25 | 29 | 27 | 100 | |
| Adhered Inclusions | | | | | |
| in Vicinity of | | | | | |
| Fitting Part (index) | | | | | |

In the stoppers of Examples 1 to 3 each of which falls within the scope of the present invention, even after 6 ch. continuous casting, no cracking or peeling-off was observed in the nose region, and the adhesion of inclusions in the vicinity of the fitting part was significantly reduced as compared to the stopper of Comparative Example 1.

The stopper of Comparative Example 1 was prepared by arranging a porous refractory material only at the end of the stopper, as shown in FIG. 4 of the Patent Document 1. The stopper of Comparative Example 1 failed to obtain the effect of suppressing the adhesion of inclusions in the vicinity of the fitting part of the stopper, resulting in an increase of the adhesion of inclusions in the vicinity of the fitting part of the stopper.

The stopper of Comparative Example 2 was prepared by arranging no high-strength refractory material on the side of the inner peripheral surface of the porous refractory material, as shown in FIG. 3 of the Parent Document 1. Since structural strength is not sufficient, in the course of the 6 ch. continuous casting, the portion of porous refractory material cracked and a nose portion of the stopper fell off. As a result, the continuous casting had to be stopped, and the adhesion of inclusions in the vicinity of the fitting part of the stopper could not be evaluated.

### LIST OF REFERENCE SIGNS

1: stopper
11: cavity
12: porous refractory material
13: higher-strength refractory material
14: fitting part
15: gas passing path
15a: gas pool (gas passing path)
15b: through-hole (gas passing path)
2: nozzle (upper nozzle)
21: fitting part
B: vertical central axis of stopper
C: nose periphery region of stopper
D: nose region of stopper

1. A stopper for continuous casting, comprising a gas flow cavity in a central part thereof, wherein, in at least part of a vertical section of a nose periphery region of the stopper, a porous refractory material having a gas permeability is arranged on the side of an outer peripheral surface of the nose periphery region, and a refractory material having higher strength than that of the porous refractory material is arranged on the side of an inner peripheral surface of the nose periphery region.

2. The stopper as claimed in claim 1, wherein the refractory material arranged on the side of the inner peripheral surface has a room-temperature bending strength of 105 or more as represented as an index calculated based on an assumption that a room-temperature bending strength of the porous refractory material is 100.

3. The stopper as claimed in claim 1, wherein in at least part of the vertical section of the nose periphery region, the porous refractory material is arranged entirely circumferentially on the side of the outer peripheral surface, or arranged on the side of an inner peripheral surface in a dispersed state and in adjacent relation to the refractory material having higher strength than that of the porous refractory material.

4. The stopper as claimed in claim 1, wherein in at least part of the vertical section of the nose periphery region, the porous refractory material has a thickness of 5 mm or more.

5. The stopper as claimed in claim 2, wherein in at least part of the vertical section of the nose periphery region, the porous refractory material is arranged entirely circumferentially on the side of the outer peripheral surface, or arranged on the side of an inner peripheral surface in a dispersed state and in adjacent relation to the refractory material having higher strength than that of the porous refractory material.
